(19) United States
(12) Patent Application Publication
(10) Pub. No.: US 2008/0068068 A1
(43) Pub. Date: Mar. 20, 2008

(54) METHOD AND SYSTEM FOR CHARGE PUMPS

(76) Inventor: Sridhar Yadala, Bangalore (IN)

Correspondence Address: KLEIN, O'NEILL & SINGH, LLP, 43 CORPORATE PARK, SUITE 204, IRVINE, CA, 92606, US

(21) Appl. No.: 11/533,067

(22) Filed: Sep. 19, 2006

(51) Int. Cl. G05F 1/10

(52) U.S. Cl. 327/536

(57) ABSTRACT

A charge pump circuit and a method for operating the charge pump circuit is provided. The circuit includes a first transistor at least coupled to an output node; a second transistor at least coupled to an input node that receives an input voltage; and a third transistor at least coupled to the input node; wherein the third transistor is disabled and the first transistor and the second transistor are enabled to create a boosting condition to facilitate a maximum charge transfer from the charge pump circuit to a next stage charge pump circuit. The method includes boosting a first capacitor and boosting a third capacitor in a first stage charge pump circuit; enabling a first and a second transistor; disabling a third transistor and boosting a gate of the first transistor; and transferring a maximum charge from the first stage charge pump circuit to a next stage charge pump circuit.

### BACKGROUND OF THE INVENTION

1. Field of the Invention

The present invention relates to semiconductor devices, and more particularly, to charge pump circuits.

2. Background

Charge pumps are used in various semiconductor systems, for example, in non-volatile memory devices (may also be referred to as flash memory devices). Charge pumps typically have plural stages. An input voltage is received at a first stage and a higher output voltage from the first stage becomes an input for the next stage. After various stages (for example, N stages), a voltage that is higher than the first stage input voltage is delivered to the appropriate destination.

Conventional charge pumps use NMOS transistors with a gate and a drain connected together operating as a switch between successive pump stages. The switch facilitates a charge transfer -to a next stage and attempts to prevent charge leakage to a previous stage. But with this type of NMOS switch, charge transfer is not maximized, because NMOS transistors require a minimum threshold voltage (VT) drop.

Vt is an inherent property of a NMOS transistor, which increases due to “body effect”. Body effect occurs because the source of a transistor is at a higher voltage than voltage at the bulk end. Vt also increases with each additional stage that is added to a charge pump circuit.

Previous solutions use numerous devices per pump stage and/or complex circuits to generate multiple phase clocks and maintain phase relation and pulse widths of these multiple phase clocks. Using multiple phase clocks has disadvantages because clock frequency cannot be increased beyond a certain limit, since clock phase requires minimum pulse width.

Semiconductor devices are also shrinking in general, while higher performance is expected from these shrinking devices. In the past, to increase output voltage, one solution has been to simply add more stages. This is not desirable in semiconductor devices (for example, flash memory) where integrated circuit size is being reduced and space on a chip is becoming sparse.

Therefore, a charge pump system and method is needed to efficiently transfer charge without increasing the number of stages or circuit complexity.

### SUMMARY OF THE INVENTION

In one aspect of the present invention, a charge pump circuit is provided. The circuit includes a first transistor at least coupled to an output node; a second transistor at least coupled to an input node that receives an input voltage; and a third transistor at least coupled to the input node; wherein the third transistor is disabled and the first transistor and the second transistor are enabled to create a boosting condition to facilitate a maximum charge transfer from the charge pump circuit to a next stage charge pump circuit.

In another aspect of the present invention, a charge pump system is provided. The system includes a plurality of charge pump circuits coupled to each other, wherein each charge pump circuit include a first transistor, at least coupled to an output node; a second transistor, at least coupled to an input node that receives an input voltage; and a third transistor, at least coupled to the input node; wherein the third transistor is disabled and the first transistor and the second transistor are enabled to create a boosting condition to facilitate a maximum charge transfer from a charge pump circuit to a next stage charge pump circuit.

In yet another aspect of the present inventions a method of operating a charge pump system is provided. The method includes boosting a first capacitor and boosting a third capacitor in a first stage charge pump circuit; enabling a first and a second transistor; disabling a third transistor and boosting a gate of the first transistor; and transferring a maximum charge from the first stage charge pump circuit to a next stage charge pump circuit.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiments are intended to illustrate, but not to limit the invention. The drawings include the following figures:

FIG. 1 is a schematic diagram of a conventional charge pump circuit.

FIG. 2 is a block diagram of a conventional charge pump system.

FIG. 3 is an equation for an output voltage of a conventional charge pump circuit.

FIG. 4A shows a first clock signal for a conventional charge pump circuit.

FIG. 4B shows a second clock signal for a conventional charge pump circuit.

FIG. 4C shows voltage distribution for a conventional charge pump circuit.

FIG. 5 is a schematic diagram of a charge pump circuit, according to an embodiment.

FIG. 6 is a block diagram of a charge pump system, according to an embodiment.

FIG. 7 shows voltage distribution for a charge pump circuit, according to an embodiment

FIG. 8 is an equation for an output voltage of a charge pump circuit, according to an embodiment.

FIG. 9 is a clock diagram for a charge pump system, according to an embodiment.

FIG. 10 is a schematic diagram of a charge pump system, according to an embodiment.

FIG. 11 is a schematic diagram of a charge pump system, according to an embodiment.

FIG. 12 is a clock diagram for a charge pump system, according to an embodiment.

FIG. 13 is a process flow diagram for operating a charge pump system, according to an embodiment.

FIG. 14 is another process flow diagram for operating a charge pump system, according to an embodiment.

### DETAILED DESCRIPTION OF THE PREFERRED EMBODIMENTS

To facilitate an understanding of the preferred embodiment, the general architecture and operation of a system for threshold voltage cancellation in high voltage charge pumps will be described. The specific architecture and operation of the preferred embodiments will then be described with reference to the general architecture.

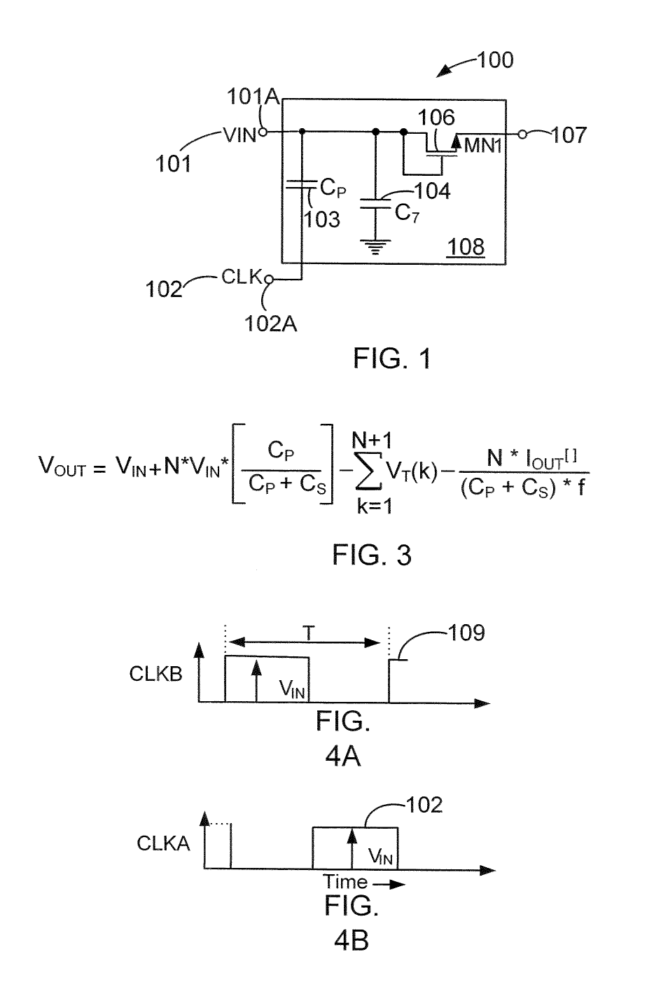

FIG. 1 is a schematic diagram of a conventional charge pump circuit 100. The circuit generally includes an input port 101A, a clock port 102A, a charge capacitor 103, a transistor 106, and an output port 107. A parasitic capacitance that is characteristic of a silicon substrate is represented by capacitor 104. The input port 101A receives an input voltage (VIN) 101. The input voltage VIN 101 and clock signal 102 are felt across charge capacitor 103.

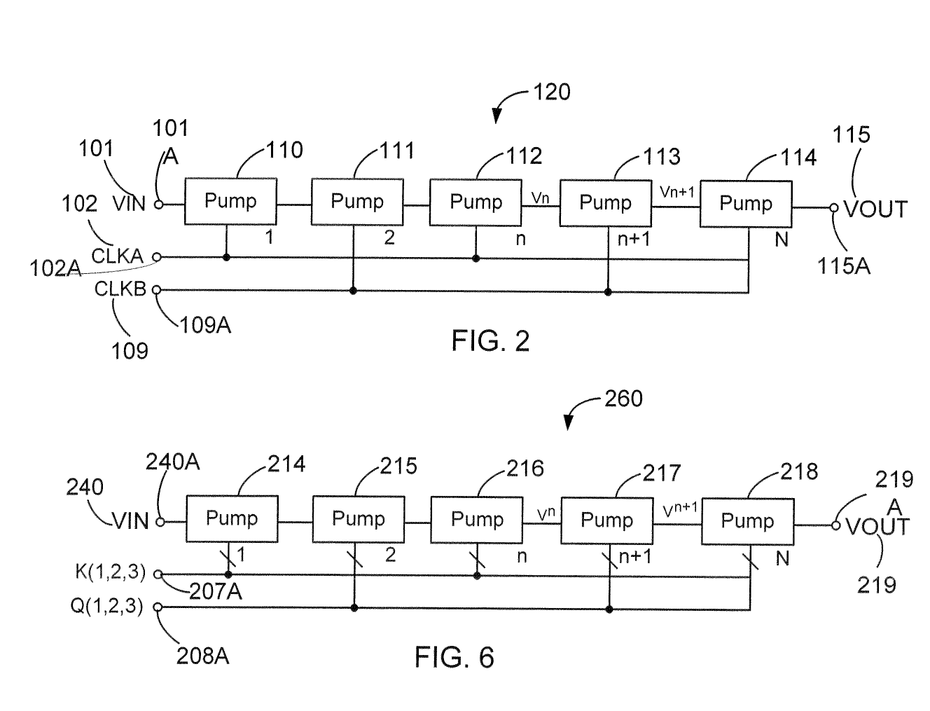

During a positive cycle of clock signal 102, transistor 106 is biased to an “on” state. This “on” state allows transistor 106 to pass a boosted voltage through port 107 to a next charge pump circuit as described below with respect to FIG. 2.

FIG. 2 shows multiple charge pump circuits 110-114 coupled to each other to form a multi-stage charge pump system 120. The multi-stage charge pump system 120 includes input port 101A, output port 115A, and clock ports 102A, 109A.

Each charge pump circuit 110-114 is similar to circuit 100 described above. The number of charge pump circuits may be increased to ‘N’.

Input voltage 101 traverses through multiple charge pump stages 110-114. The voltage increases at each stage and output VOUT 115 is generated. VOUT 115 is greater than VIN 101.

System 120 starts operating when clock signal CLK A (may also be referred to as “CLK A”) 102 is received. The first stage charge pump circuit 110 increases input voltage VIN 101. The increased VIN 101 is then transferred to the next stage during a positive cycle of CLK A (102).

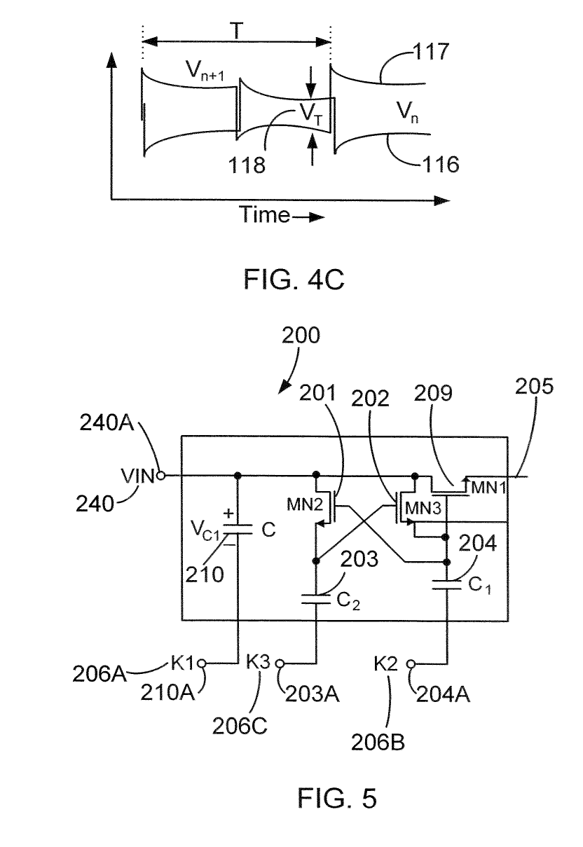

Clock signal CLK B (may also be referred to as “CLK B) 109 is out of phase with CLK A 102 (as shown in FIG. 4A and 4B). This condition causes transistor 106 to bias to an “off” condition. This process is repeated for each successive charge pump stage 111-114, until VOUT 115 is generated, which is greater than VIN 101.

FIG. 3 shows an equation for VOUT 115. A voltage drop, Vt occurs across transistor 106 during the charge transfer phase. Vt increases substantially as input voltage VIN 101 is increased in successive charge pump stages because of body effect. Therefore, charge transfer from VIN 101 to VOUT 115 is not maximized.

FIG. 4C graphically illustrates voltage distribution for charge pump system 120 over time. By example, waveform 116 represents input voltage VIN 101 and waveform 117 represents output voltage VOUT 115 of charge pump system 113. As shown at location 118, the threshold voltage, Vt is nonzero and it increases with successive charge pump circuits due to body effect of transistor 106. This prevents maximum charge transfer between individual charge pump circuits.

Conventional systems simply increase the number of stages to maximize charge transfer. For example, the value of N (FIG. 2) will increase to N+1, N+2, . . . N+M. This is not desirable for integrated circuits that continue to shrink in size. The adaptive aspects of the present invention solve this problem efficiently as described below.

Charge Pump System

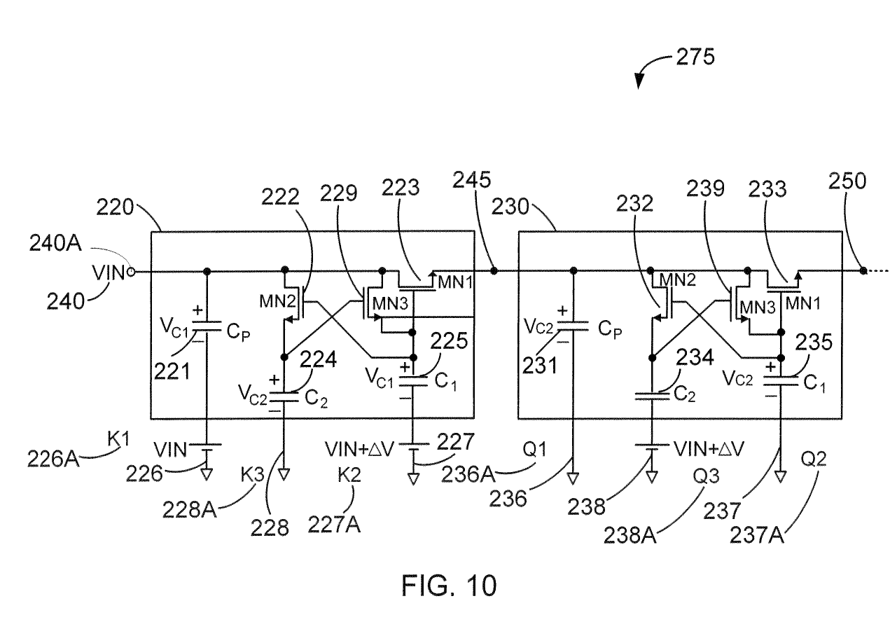

FIG. 5 shows a charge pump circuit 200, according to one aspect of the present invention. Charge pump circuit 200 generally includes input port 240A, output port 205, transistors 201, 202, 209, and capacitors 203, 204, 210. Further, included are clock signals K1 (206A (or 226A, FIG. 10)), K2 (2065 (or 227A, FIG. 10)), and K3 (206C (or 228A, FIG. 10)) at clock ports 210A, 204A, and 203A, respectively. Input voltage signal VIN (240) is received at input port 240A.

Transistors 201, 202, 209 are NMOS (N Channel Metal Oxide Field Effect Transistor) transistors suited for high voltage operation. The transistors. Methods of fabrication of suitable transistors for charge pump circuits are well known in the art, and any number of fabrication methods may be used to fabricate the transistors and other components of charge pump circuit 200.

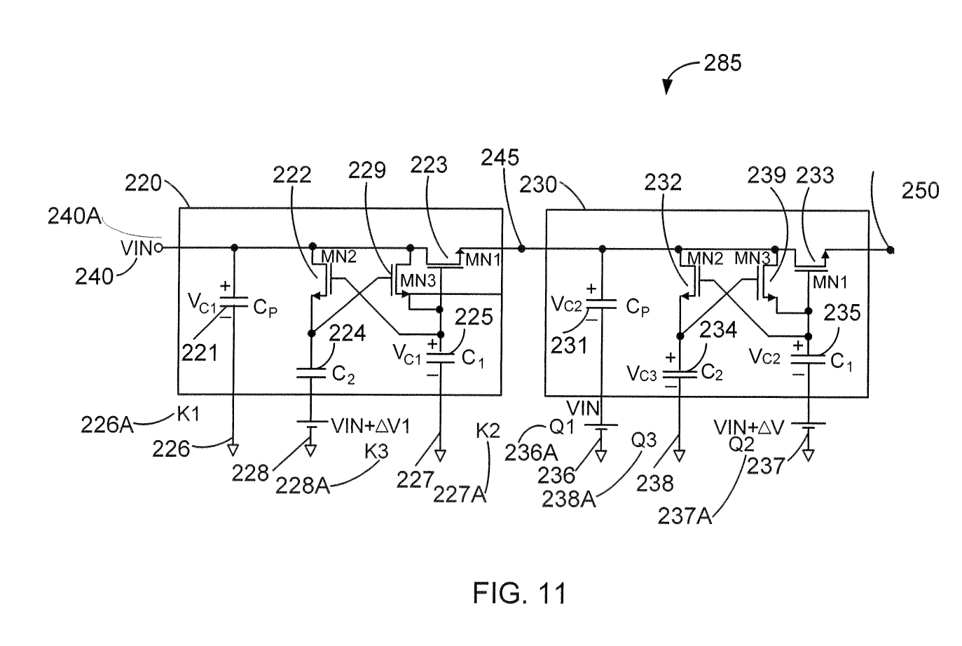

Capacitors 203, 204 and 210 provide biasing and charging functions for charge pump circuit 200 In one aspect, capacitors 203, 204, 210 occupy a smaller area of circuit space than a conventional charge pump circuit 100. Smaller capacitors 203, 204, 210 may supply the same amount of charge that larger capacitors of conventional circuit 100 supply, since charge pump circuit 200 is more efficient (as described below with respect to FIGS. 10 and 11) than conventional charge pump 100. This increased efficiency facilitates a reduced die size during fabrication process for charge pump circuit 200.

FIG. 6 shows a block diagram of charge pump 260, according to another aspect of the present invention. The multi-stage charge pump system 260 includes input port 240A, output port 219A, and clock ports 207A, 208A. Multi-stage charge pumps 214-218 operate to increase input voltage VIN (240) to output voltage VOUT (219). VIN (240) increases at each stage of the multiple stages 214-218.

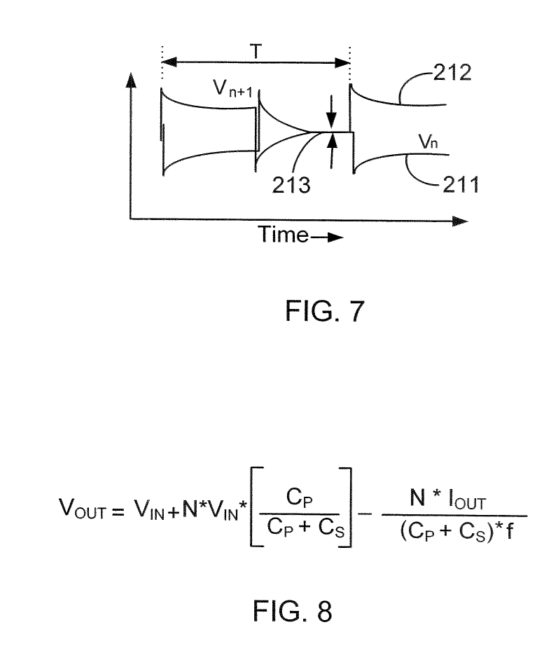

FIG. 7 shows voltage distribution for charge pump system 260. By example, waveform 211 represents input voltage VIN 240 (similar to 101) and waveform 212 represents output voltage VOUT 205 for charge pump circuit 217. As shown at location 213, threshold voltage loss may be eliminated because Vt drop across transistor 209 is minimized to zero during the charge transfer phase, as described below with respect to FIGS. 10-11.

FIG. 8 shows an equation for VOUT (219), according to one aspect of the present invention. The impact of Vt on VOUT (219) is reduced since Vt loss in each stage charge pump circuit is eliminated. Further, Vt falls out of the equation shown in FIG. 3 since the drain and source of transistor 209 is effectively shorted, as described below.

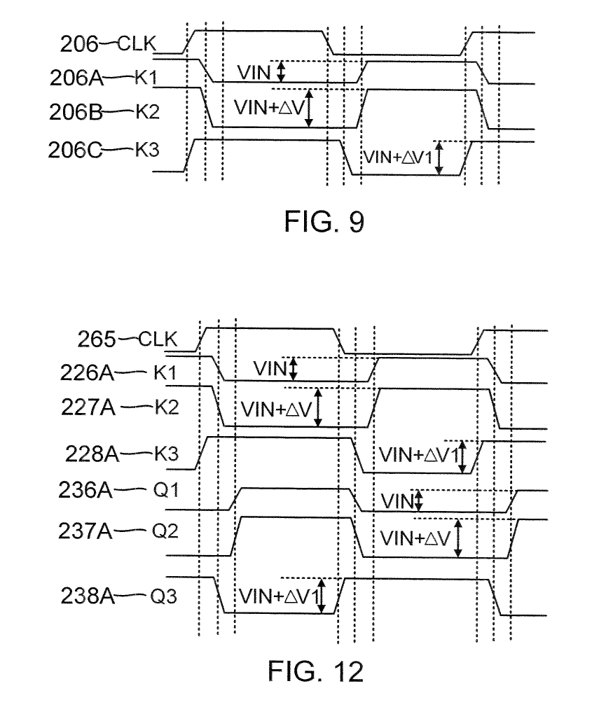

FIG. 9 shows a clock diagram for charge pump system 200 according to one aspect of the present invention. Generally included are clock signals K1 (206A), K2 (206B) and K3 (206C). System clock signal CLK (206) is used to derive multiple clocks K1, K2, K3. Clock signals K1, K2, K3 are non-overlapping with Q1, Q2 and Q3 respectively.

As shown in FIG. 9, amplitude of K1 (206A) is equal to VIN, amplitude of K2 (206B) is equal to VIN+ΔV, and amplitude of K3 (206C) is equal to VIN+ΔV1. The voltage at K2 (206B) and K3 (206C) is greater than the voltage at K1 (206A) because greater voltage is needed to properly bias transistors 201, 202, 209 during each half cycle of system clock CLK.

FIG. 10 shows an example of a charge pump system 275 according to one aspect of the present invention. System 275 includes charge pump stage 220 and charge pump stage 230 which are both similar to charge pump circuit 200 System clock CLK 206 is equal to zero for the FIG. 10 circuit. Charge pump stages 220, 230 may be coupled together by connection 245.

Charge pump stage 220 includes input port 240A, and charge pump stage 230 includes output port 250. The operation of the charge pump system 275 will be understood better with respect to the clock diagram of FIG. 12.

When system clock CLK (shown as 206 in FIG. 9 or 265 in FIG. 12)) transitions from a high value to zero, voltage at clock port 228 transitions from a high to zero volts after a finite delay, thereby biasing transistor 229 to an “off” condition. After a finite time delay, the voltage at clock ports 226 and 227 rise from zero volts to a higher value. The high value at clock port 226 is equal to VIN and the high value at clock port 227 is equal to VIN plus ΔV. The high values at clock ports 226 and 227 create a boosting condition at the upper plates of capacitors 225, 221. The boosting condition of capacitor 225, which is connected to the gate of transistors 222 and 223, causes transistors 222 and 223 to bias to an “on” condition.

The biased “on” condition of transistors 222 and 223 create a charge transfer condition between charge pump stages 220 and 230. This facilitates a maximum charge transfer from capacitor 221 to capacitors 231 and 235 of charge pump stage 230, and to capacitor 224 of charge pump stage 220. Capacitors 231 and 235 are charged to a voltage VC2. During the charge transfer condition, the voltage drop across transistor 223 is zero or almost zero, thereby maximizing charge transfer to the next charge pump stage 230.

FIG.11 shows a charge pump system 285, which includes charge pump stages 220, 230, according to one aspect of the present invention. FIG. 11 shows a circuit for charge pump system 285 when system clock CLK 265 (or 206) transitions from a low (zero) to high value. When system clock CLK 265 is high, voltage at clock port 228 rises from zero volts to a higher voltage. The higher voltage at clock port 228 is equal to VIN plus ΔV1, creating a boosting condition at capacitor 224.

The boosting condition of capacitor 224 increases gate voltage of transistor 229, thereby switching transistor 229 to an “on” condition. After a finite time delay, as seen in FIG. 12, the voltage at clock ports 226 and 227 transitions from a higher value to zero. The zero voltage at clock port 227 bias transistors 222 and 223 to an “off” condition.

Switching “on” transistor 229 effectively shorts the gate and drain of transistor 223. Further, while the transistor 229 is switched “on”, transistor 223, in an “off” condition, acts as a diode or as an on/off switch. This allows transistor 223 to block any charge that may transfer in a reverse direction from the second stage charge pump 230. While transistor 229 is still switched “on”, capacitor 225 continues to charge.

As shown in FIG. 12, after a finite time delay, clock signals Q1 (236A), Q2 (237A) ramp up to a high voltage shortly after clock signals K1 (226A (same as 206A)), K2 (227A (same as 206B)) transition to zero volts High voltage value of Q1 (236A) is equal to VIN, and high voltage value of Q2 (237A) is equal to VIN plus ΔV. The same procedure as described for stage one charge pump 220 is repeated for second stage charge pump 230 using clock signals Q1 (236A), Q2 (237A), Q3 (238A). Further, the procedure used for first stage charge pump 220 is repeated for each charge pump stage for a multi-stage charge pump system having more than two stages.

In one aspect of the present invention, the foregoing charge pump system is suitable for all electrically field programmable nonvolatile memories such as EEPROMS, NOR and NAND flash memories.

There are currently many different types of flash memory cards than are commercially available, examples being the CompactFlash (CF), the MultiMediaCard (MMC), Secure Digital (SD), miniSD, Memory Stick, SmartMedia and TransFlash cards. Although each of these cards has a unique mechanical and/or electrical interface according to its standardized specifications (for example, The Universal Serial Bus (USB) specification, incorporated herein by reference in its entirety), the flash memory included in each is very similar. These cards are all available from SanDisk Corporation, assignee of the present application.

SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host devices that use such memory cards and flash drives are many and varied. They include personal computers (PCs), laptop and other portable computers, cellular telephones, personal digital assistants “PDAs), digital still cameras, digital movie cameras and portable audio players. The host typically includes a built-in receptacle for one or more types of memory cards or flash drives but some require adapters into which a memory card is plugged.

A NAND architecture of the memory cell arrays is currently preferred, although other architectures, such as NOR, can also be used instead. Examples of NAND flash memories and their operation as part of a memory system may be had by reference to U.S. Pat. Nos. 5,570,315, 5,7747397, 6,046,935, 6,373,746, 6,456,528, 6,522,580, 6,771,536 and 6,781,877 and United States patent application publication no. 2003/0147278.

Process Flow:

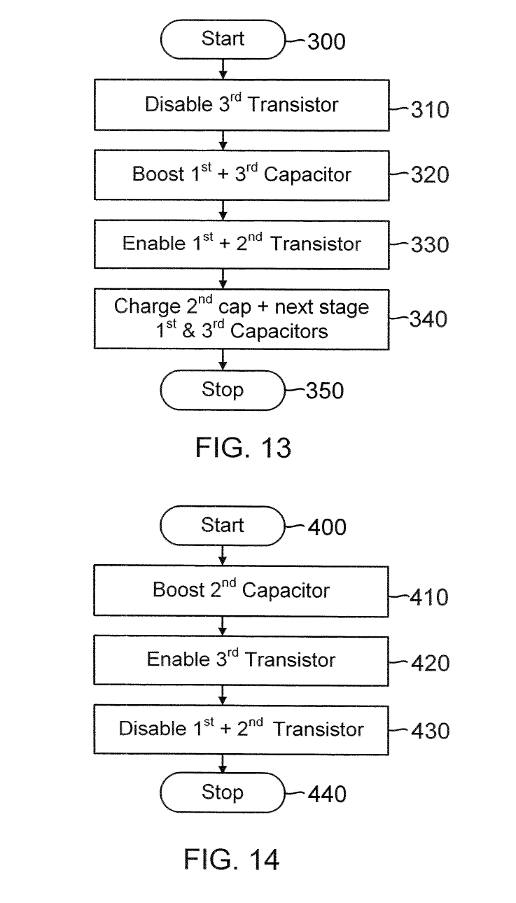

FIG. 13 shows a process flow diagram for operating charge pump system 275 according to one aspect of the present invention. The flow diagram of FIG. 13 assumes that system clock signal CLK (265) is equal to zero. The process begins at step 300.

In step 310, third transistor (229) of first stage charge pump (220) is disabled. In step 320, first capacitor (225) and third capacitor (221) of first stage charge pump (220) are boosted. In step 330, first transistor (223) and second transistor (222) of first stage charge pump (220) are enabled. In step 340, first capacitor (235), third capacitor (231) of second stage charge pump (230) and second capacitor (224) of first stage are charged. In step 350, the process ends.

FIG. 14 shows a process flow diagram for operating charge pump system 285, according to yet another aspect of the present invention. The flow diagram of FIG. 14 assumes that system clock signal CLK (265) is high (for example, 1). The process begins at step 400.

In step 410, second capacitor (224) of first stage charge pump (220) is boosted. In step 420, third transistor (229) of first stage charge pump (220) is enabled. In step 430, first transistor (223) and second transistor (222) of first stage charge pump (220) are disabled for minimizing charge leakage from second stage charge pump 230. In step 440, the process ends.

The processes of FIG. 13 and FIG. 14, continues at the second stage charge pump 230 when a first and a third capacitor of the second stage charge pump is charged.

In one aspect of the present invention, charge transfer is maximized without adding complex circuitry or additional stages.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A charge pump circuit, comprising:
a first transistor at least coupled to an output node;
a second transistor at least coupled to an input node that receives an input voltage; and
a third transistor at least coupled to the input node; wherein the third transistor is disabled and the first transistor and the second transistor are enabled to create a boosting condition to facilitate a maximum charge transfer from the charge pump circuit to a next stage charge pump circuit.

2. The charge pump circuit of claim 1, wherein the first transistor is coupled to a first capacitor.

3. The charge pump circuit of claim 1 wherein the second transistor is coupled to a second capacitor.

4. The charge pump circuit of claim 1, wherein the third transistor is coupled to a first capacitor.

5. The charge pump circuit of claim 1, wherein a third capacitor is connected to the input node.

6. The charge pump circuit of claim 1, wherein the first transistor and the second transistor are disabled to minimize leakage from the next stage charge pump circuit.

7. The charge pump circuit of claim 1, further comprising:
a first clock node coupled to a third capacitor;
a second clock node coupled to a first capacitor; and
a third clock node coupled to a second capacitor;
wherein a voltage of the first clock node and the second clock node are high when a voltage of the third clock node is low, and the voltage of the first clock node and the second clock node are low when the voltage of the third clock node is high.

8. The charge pump circuit of claim 7, wherein the voltage of the second clock node is higher than the voltage of the first clock node when the second clock node and the first clock node are high.

9. The charge pump circuit of claim 1, wherein the first transistor; the second transistor and the third transistor are NMOS transistors.

10. The charge pump circuit of claim 1, wherein the charge pump circuit is used in a non-volatile memory device.

11. A charge pump system, comprising:
a plurality of charge pump circuits coupled to each other, wherein each charge pump circuit comprising:
a first transistor at least coupled to an output node;
a second transistor at least coupled to an input node that receives an input voltage; and
a third transistor at least coupled to the input node; wherein the third transistor is disabled and the first transistor and the second transistor are enabled to create a boosting condition to facilitate a maximum charge transfer from a charge pump circuit to a next stage charge pump circuit.

12. The charge pump system of claim 11, wherein the first transistor is coupled to a first capacitor.

13. The charge pump system of claim 11, wherein the second transistor is coupled to a second capacitor.

14. The charge pump system of claim 11, wherein the third transistor is coupled to a first capacitor.

15. The charge pump system of claim 11, wherein a third capacitor connected to an input node.

16. The charge pump system of claim 11 wherein the first transistor and the second transistor are disabled to minimize leakage from one charge pump circuit to another charge pump circuit.

17. The charge pump system of claim 11, wherein the first transistor; the second transistor and third transistor are NMOS transistors.

18. The charge pump system of claim 11, wherein the charge pump circuit is used in a non-volatile memory device.

19. A method of operating a charge pump system, the method comprising:
boosting a first capacitor and boosting a third capacitor in a first stage charge pump circuit;
enabling a first and a second transistor;
disabling a third transistor and boosting a gate of the first transistor; and
transferring a maximum charge from the first stage charge pump circuit to a next stage charge pump circuit.

20. The method of claim 19, wherein a system clock signal is set to zero.

21. The method of claim 19, further comprising:
boosting a second capacitor;
enabling the third transistor; and
disabling the first transistor and the second transistor for minimizing a charge leakage from the next stage charge pump circuit to the first stage charge pump circuit.

22. The method of claim 19, wherein a system clock signal is set to a high voltage.

23. The method of claim 19, wherein the charge pump system is used in non-volatile memory devices.

24. The method of claim 19, wherein the first transistor; the second transistor and third transistor are NMOS transistors.
